(19) United States
(12) Patent Application Publication
(10) Pub. No.: US 2020/0387961 A1
(43) Pub. Date: Dec. 10, 2020

(54) INTELLIGENT SYSTEM FOR COOPERATIVE BID RESPONSE AND PROJECT PLAN GENERATION

(71) Applicant: International Business Machines Corporation, Armonk, NY (US)

(72) Inventors: Abhishek MITRA, BANGALORE (IN); Shefali BANSAL, BANGALORE (IN)

(21) Appl. No.: 16/430,429

(22) Filed: Jun. 4, 2019

(51) Int. Cl. G06Q 30/08; G06Q 10/06

(52) U.S. Cl. CPC G06Q 30/08; G06Q 10/06313

(57) ABSTRACT

In optimizing bid response and project execution plan generation, a system compares current bid requirements of a current bid with prior bid requirements of prior bids. For prior bids with prior bid requirements matching the current bid requirements, the system retrieves corresponding prior bid responses with a prior bid response status of win and retrieves prior projects corresponding to the prior bid responses. The system determines candidate bid response parameters with a highest probability of winning the current bid and with a probability of project success meeting a minimum threshold. The system generates a current bid response to include the candidate bid response parameters. After winning the current bid, the system determines candidate project plan parameters with highest probability of project success and generates a current project corresponding to the current bid response to include the candidate project plan parameters.

### BACKGROUND

When a potential customer requires services for a project, the customer typically distributes bids to potential providers. The bid includes a set of requirements for the project. Each interested provider creates and submits a bid response that includes various parameters on how the organization will meet the needs of the project. When an organization wins the bid, the organization then creates a project execution plan for delivering the goods or services.

However, the bid response generation process and the project plan generation process are typically separate processes operating with different goals. The goal of the bid response generating process is to win the bid, while the goal of the project execution plan process is to deliver the promised results. Conventional bid response and project execution plan generation processes are not integrated, where bid responses are generated without sufficient consideration for the requirements for the successful execution of the project. This can lead to bid responses which are overly aggressive, which increases the chances of winning the bid but may inadvertently lower the chances of successfully executing the project. However, overly conservative bid responses may increase the chances of successful project execution but would lower the chances of winning the bid. Due to the lack of integration between the two processes, unintentional difficulties in winning bids or successfully executing projects may result.

### SUMMARY

Disclosed herein is a system for optimized bid response and project execution plan generation, and a computer program product and method as specified in the independent claims. Embodiments of the present invention are given in the dependent claims. Embodiments of the present invention can be freely combined with each other if they are not mutually exclusive.

According to an embodiment of the present invention, a system compares current bid requirements of a current bid with prior bid requirements of prior bids. For prior bids with prior bid requirements matching the current bid requirements, the system retrieves prior bid responses corresponding to the prior bids and comprising a prior bid response status of win. The system further retrieves prior projects corresponding to the prior bid responses. The system determines a set of candidate bid response parameters with a highest probability of winning the current bid and with a probability of project success meeting a configured minimum threshold, based on the prior bid responses and the prior projects. The system generates a current bid response to include the candidate bid response parameters. After winning the current bid, the system determines a set of candidate project plan parameters with highest probability of project success, based on the current bid response, the prior bid responses, and the prior projects. The system generates a current project corresponding to the current bid response to comprise the candidate project plan parameters.

### BRIEF DESCRIPTION OF THE DRAWINGS

FIG. 1 illustrates structures of bids, bid responses, and projects according to some embodiments.

FIG. 2 illustrates a method for optimized bid response and project execution plan generation according to some embodiments.

FIG. 3 illustrates in more detail the bid response process according to some embodiments.

FIG. 4 illustrates in more detail the project execution process according to some embodiments.

FIG. 5 illustrates a flow of the bid response process according to some embodiments.

FIG. 6 illustrates a flow of the project execution process according to some embodiments.

FIGS. 7A and 7B illustrate an example of the bid response process according to some embodiments.

FIG. 8 illustrates an example of the project execution process according to some embodiments.

FIG. 9 illustrates a logical system for optimized bid response and project execution plan generation according to some embodiments.

FIG. 10 illustrates a computing environment for optimized bid response and project execution plan generation according to some embodiments.

FIG. 11 illustrates a computer system, one or more of which implements the system for optimized bid response and project execution plan generation according to some embodiments.

### DETAILED DESCRIPTION

A system in accordance with some embodiments of the present invention balances the chances of winning a bid with the chances of successful execution of a corresponding project through an iterative optimization technique, as described herein. The system includes two processes. In a first process, the system assists in generating a bid response that has a higher chance of winning a bid while maintaining at least a minimum chance of successful project execution. In a second process, after winning the bid, the system optimizes the project execution plan for a winning bid response to increase the chances of successful execution given the constraints imposed by the winning bid response.

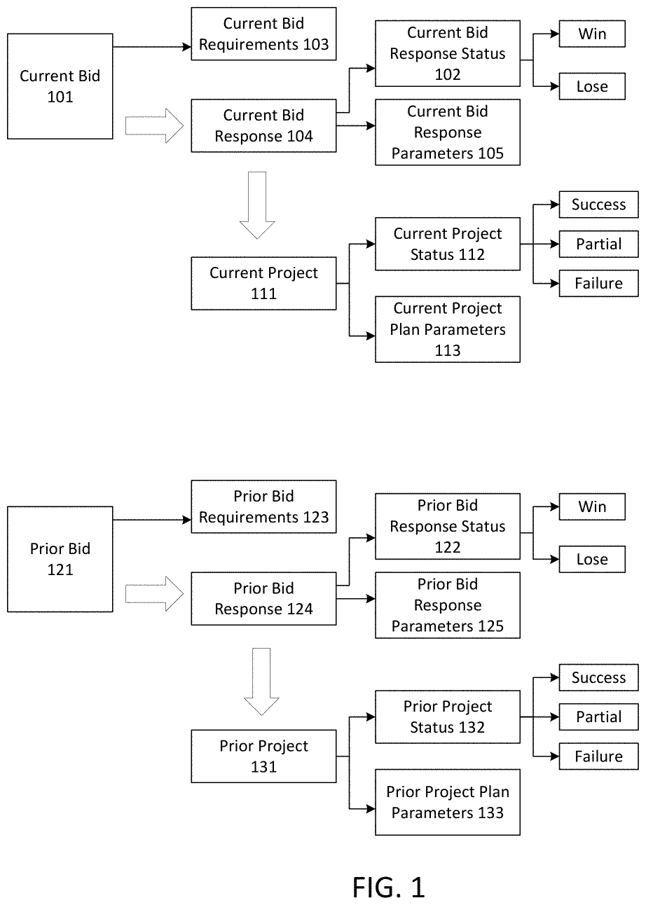

FIG. 1 illustrates structures of bids, bid responses, and projects according to some embodiments. A pending or current bid 101 includes a set of current bid requirements 103, which describes the constraints of requested goods or services. An organization interested in the current bid 101 generates a corresponding current bid response 104 that includes a set of current response parameters 105 and a current bid response status 102. The current response parameters 105 describes how the organization proposes to satisfy the bid requirements 103. The current bid response status 102 indicates whether the current bid response 104 wins or loses the bid. The current bid response status 102 is initially set to a null value and is updated upon an acceptance or rejection of the current bid response 104. Once the current bid response 104 is accepted, i.e., wins the bid, a corresponding current project 111 is generated to include a current project status 112 and current project plan parameters 113. The current project plan parameters 113 define the execution plan for the project. The current project status 112 is then set to indicate whether the current project was executed successfully (i.e., met the current bid requirements), partially successful (i.e., met some of the current bid requirements but not others), or failure (i.e., failed to meet the bid requirements).

The system further stores a history of bids, bid responses, and projects. Each prior bid 121 includes prior bid requirements 123 describing the constraints of previously requested goods or services. Corresponding to each prior bid are one or more prior bid responses 124, each comprising prior response parameters 125 which described how an organization proposed to satisfy the prior bid requirements 123, and a prior bid response status 122 indicating whether the bid was won or lost. For the prior bid response 124 that were won, the history includes a corresponding prior project 131, which includes prior project plan parameters 133 and a prior project status 132. The prior project plan parameters 133 defined the execution plan for the project, and the prior project status 132 includes whether the project execution was a success, a partial success, or a failure.

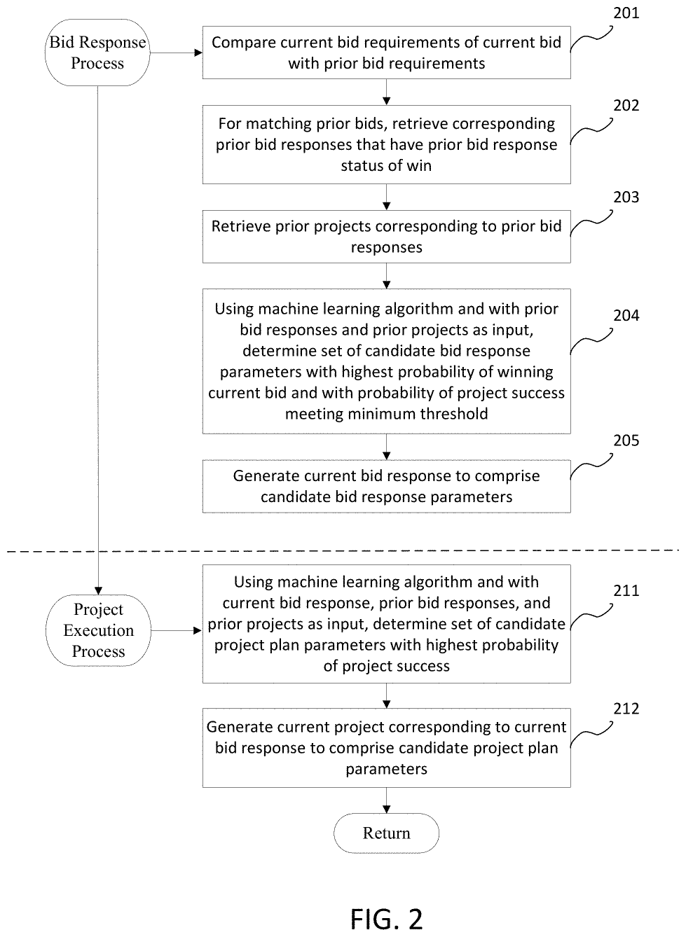

FIG. 2 illustrates a method for optimized bid response and project execution plan generation according to some embodiments. The method includes two processes or stages. In a bid response process or stage, the system assists in generating a current bid response that has a highest chance of winning a bid while maintaining at least a minimum chance of successful project execution. In a project execution process or stage, after the current bid response wins the bid, the system generates an optimized project execution plan that satisfies the bid response and that has the highest chance of successful project execution. The system is configured with access to a history of prior bids, prior bid responses, and prior projects.

In the bid response process, the system compares current bid requirements 103 of a current bid 101 with prior bid requirements 123 of prior bids 121 (201). For the prior bids 121 with prior bid requirements 123 matching the current bid requirements 103, the system retrieves the corresponding prior bid responses 124 that have a prior bid response status 122 of a win (202). The system further retrieves the prior projects 131 corresponding to the prior bid responses 124 (203). Using a machine learning algorithm and with the prior bid responses 124 and prior projects 131 as input, the system determines a set of candidate bid response requirements with the highest probability of winning the current bid 101 and with a probability of project success that meets a minimum threshold (204). The system then generates the current bid response 104 to comprise the set of candidate bid response parameters as the current response parameters 105 (205).

After the current bid response 104 wins the current bid 101, the system implements the project execution process. Using a machine learning algorithm and with the current bid response 104, prior bid responses 124, and prior projects 131 as input, the system determines a set of project plan parameters 113 with a highest probability of project success (211). The system generates the current project 111 to comprise the candidate project plan parameters as the current project plan parameters 113 (212).

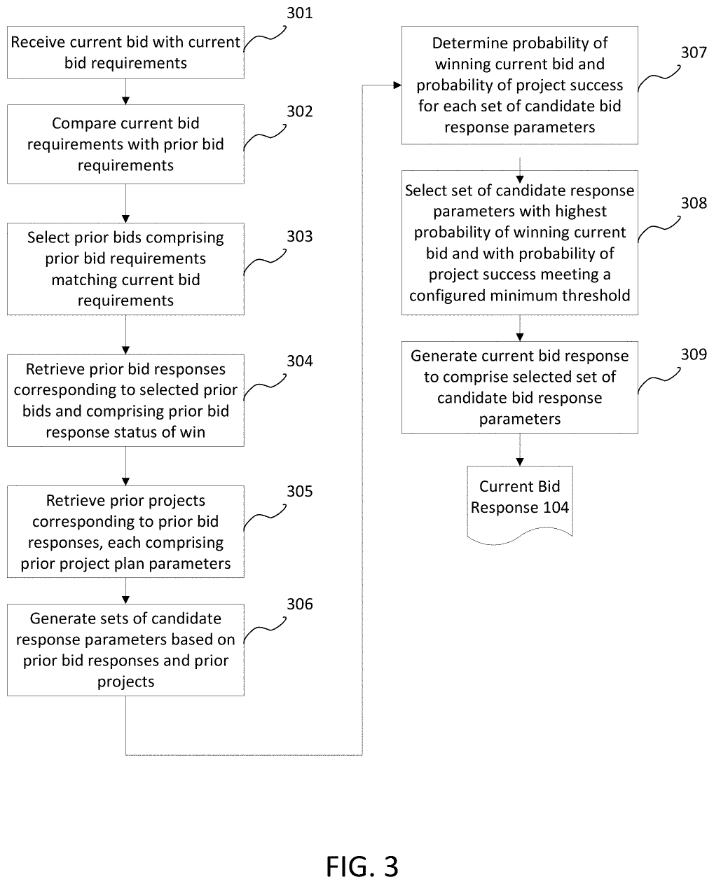

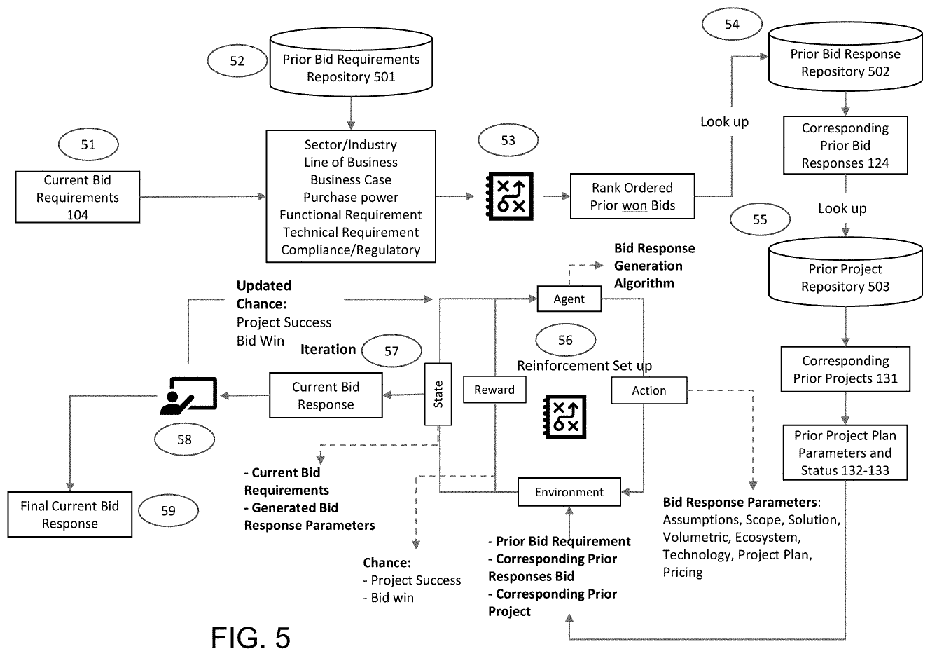

FIG. 3 illustrates in more detail the bid response process according to some embodiments. FIG. 5 illustrates a flow of the bid response process according to some embodiments. Referring to FIGS. 3 and 5, the system receives the current bid 101 with the current bid requirements 103 (301, 51). The system is configured with access to prior bid requirements 123 of prior bids 121 (302, 52) stored in a prior bid requirement repository 501. Using a machine learning algorithm, the system compares the current bid requirements 103 with the prior bid requirements 123 of prior bids 121 (302, 53) Example bid requirements compared may include, but are not limited to: sector or industry; line of business; business case; purchase power; functional requirement(s); technical requirement(s); and compliance or regulatory requirements. The system selects the prior bids 121 comprising prior bid requirements 123 matching the current bid requirements 103 (303). Optionally, only the prior bids which were won are considered. The prior bids can be ordered or ranked with only a portion of the ranked prior bids considered. The system retrieves, from a prior bid response repository 502, the prior responses 124 corresponding to the selected prior bids 121 and comprising a current bid response status of win (304, 54). The system further retrieves the prior projects 131 corresponding to the prior bid responses, where each prior project comprises prior project plan parameters 133 (305, 55). Using an iterative process according to a reinforcement learning setup (56), the system generates sets of candidate bid response parameters based on the prior bid responses 124 and prior projects 131 (306). Example bid response parameters may include, but are not limited to: assumptions; scope; solution; volumetric; ecosystem; technology; project plan; and pricing. For each set of candidate bid response parameters, the system determines the probability of winning the current bid 101 and the probability of project success (307). Through the reinforcement learning (56), the system selects the set of candidate bid response parameters with the highest probability of winning the current bid 101 and with the probability of project success meeting a configured minimum threshold (308). The system generates the current bid response 104 to comprise the selected set of candidate bid response parameters as the current bid response parameters 105 (309). The output of the reinforcement learning is thus the current bid response 104 (57). Referring to FIG. 5, optionally, the current bid response 104 may be reviewed by an expert user (58). If the expert user recommends further modifications to the current bid response 104, the current bid response with the expert user modifications are processed by the reinforcement learning algorithm to determine whether the balance of the probabilities of winning the bid and project success is improved. Through this processing, the expert user modifications are either accepted, or the current bid response is fully or partially further modified and processed to generate the final current bid response (59).

Reinforcement learning is a type of machine learning technique that enables an “agent” to learn in an interactive environment by trial and error using feedback from its own actions and experiences. Reinforcement learning is modeled with an “agent”, an “environment”, an “action”, and a “reward”. An agent is an entity which performs actions in an environment to gain some reward. An action is a set of all possible moves the agent can make. An environment is a scenario the agent has to face. The environment takes the agent's current state and action as input, and returns as output the agent's reward and its next state. A state is a current situation returned by the environment. A reward is an immediate return sent back from the environment to evaluate the last action by the agent. In the context of the bid response process, the action is to generate bid responses. The environment includes the prior bid requirements 103, the corresponding prior bid responses 124, and the corresponding prior projects 131. The state is the current bid requirements 103 and the generated current bid response 104 and its parameters 105. The reward is the highest probability of winning the current bid 101 with the probability of successful project execution meeting the configured minimum threshold. Unlike supervised learning, where feedback provided to the agent contains the correct set of actions for performing a task, reinforcement learning uses rewards and punishment as signals for positive and negative behavior. As compared to unsupervised learning, reinforcement learning is different in terms of goals. While the goal in unsupervised learning is to find similarities and differences between data points, in reinforcement learning the goal is to find a suitable action model that would maximize the total cumulative reward of the agent. Reinforcement learning is able to run through the same states over and over again while experimenting with different actions, until it can infer which actions are best from which states. Reinforcement learning addresses the difficult problem of correlating immediate actions with delayed returns. In a delayed return environment, it can be difficult to understand which actions lead to which outcomes over many time steps. Reinforcement learning differs from humans in its ability to run parallel experiments at once and/or allows actions to be input into a “black box” environment to receive a maximized rewards output, where the environment is extracted at least from prior bid responses and prior project repositories without requiring human input or knowledge.

Conventionally, the bid response generation and project execution operations are different operations with different motivations or goals. The people involved in the two operations are often not the same and a span of time and multiple steps or events commonly exist between them. In applying reinforcement learning according to the present invention, cooperative consideration of the actions and rewards is realized between the bid response and project plan execution generation. Unlike the known and conventional manner of generating bid responses separately from the project execution plan generation, embodiments of the present invention provide an end to end intelligent framework that can scientifically balance the interest of the bid response and project execution functions through the iterative optimization techniques of reinforcement learning.

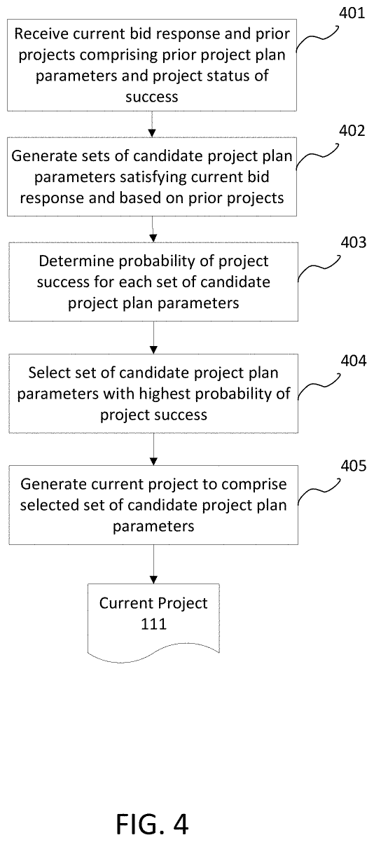

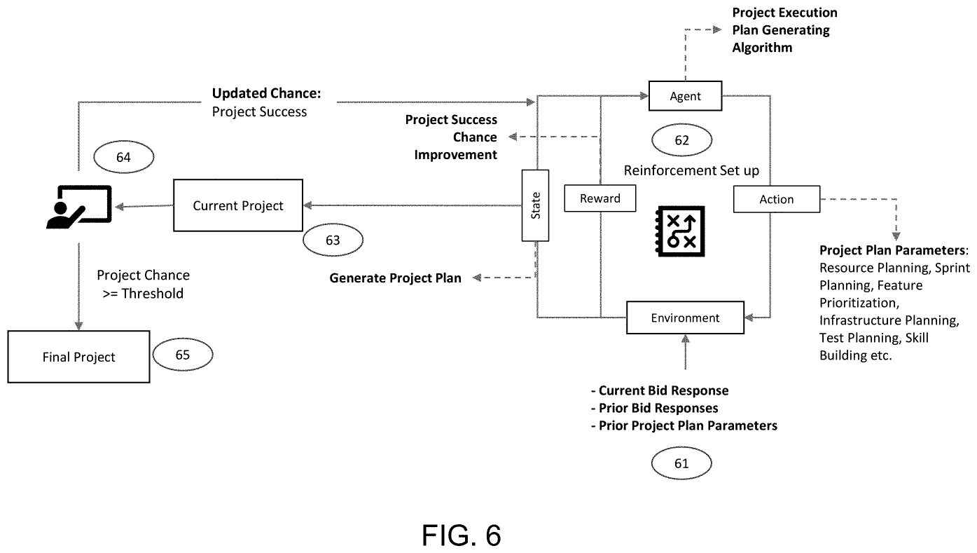

FIG. 4 illustrates in more detail the project execution process according to some embodiments. FIG. 6 illustrates a flow of the project execution process according to some embodiments. Referring to both FIGS. 4 and 6, the system receives as input the current bid response 104, prior bid responses 124, and prior projects 131 with prior product status of ‘success’ (401, 61). Using reinforcement learning (62), the system generates sets of candidate project plan parameters that satisfy the current bid response 104, based on the prior projects 131 (402). The system determines the probability of project success for each set of candidate project plan parameters (403). The system selects the set of candidate project plan parameters with the highest probability of project success (404). The system generates the current project 111 to comprise the selected set of candidate project plan parameters as the current project plan parameters 113 (405, 63). Referring to FIG. 6, optionally, the current project 111 may be reviewed by an expert user (64). If the expert user recommends further modifications to the current project 111, the current project 111 with the expert user modifications are processed by the reinforcement learning setup to determine whether the probability of project success is improved. Through this processing, the expert user modifications are either accepted, or the current project is fully or partially further modified and processed to generate the final project (65).

In the context of the project execution process, the action in the reinforcement learning is to generate the candidate project plan parameters. The environment includes the current bid response 104, prior projects 131, and the corresponding prior project plan parameters 133. The state is the project plan. The reward is to maximize the probability of project success from the current state.

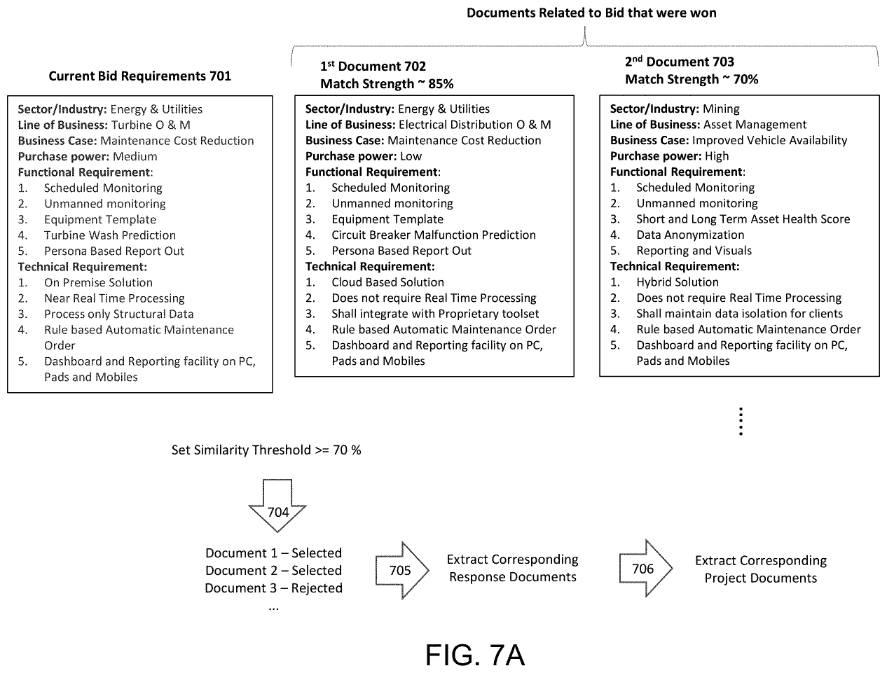

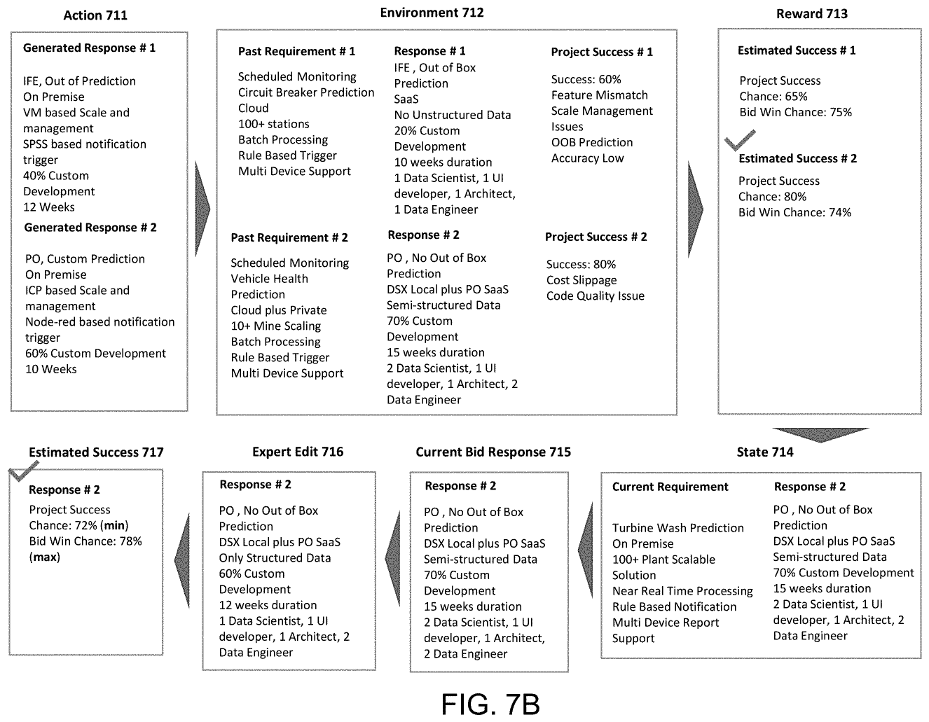

FIGS. 7A and 7B illustrate an example of the bid response process according to some embodiments. Referring to FIGS. 3 and 7A-7B, the system receives the example current bid requirements 701 (301). The current bid requirements 701 are compared with the prior bid requirements 123 in prior bids 121 (302), such as example first document 702, example second document 703, etc. Assume that the first document 702 has a match strength of 85% while the second document 703 has a match strength of 70%. Assume also that a similarity threshold is configured to be 70%. The system selects the documents (i.e., prior bids) with a match strength that meets the similarity threshold (303, 704). The system then retrieves or extracts the bid response documents corresponding to the selected documents (304, 705). The system also retrieves or extracts the project documents corresponding to the extracted bid response documents (305, 706). FIG. 7B illustrates example sets of candidate bid response parameters (Action 711) based on the bid response documents and project documents retrieved per 705 and 706 (Environment 712) (306). The system determines the probability of winning the bid and the probability of project success for each set of candidate response parameters (Reward 713) (307). The system selects the set of candidate response parameters with the highest probability of winning the bid and with probability of project success meeting a configured minimum threshold (State 714) (308). Assume that the minimum threshold is configured to be 70%. The system generates the current bid response to comprise the selected set of candidate bid response parameters (Current Bid Response 715) (309). In this example, an expert user edits the current bid response 715 (Expert Edit 716). The edited current bid response 716 is input into the reinforcement learning setup to determine whether the balance between the probability of winning the bid and the probability of project success is maintained or improved (Estimated Success 717). In this example, the probability of winning the bid is improved from 74% to 78%, and the probability of project success decreases from 80% to 72%. However, the probability of project success still meets the minimum threshold of 70% and thus the chances of winning the bid is increased while the chances of successful execution of the project is maintained above the minimum.

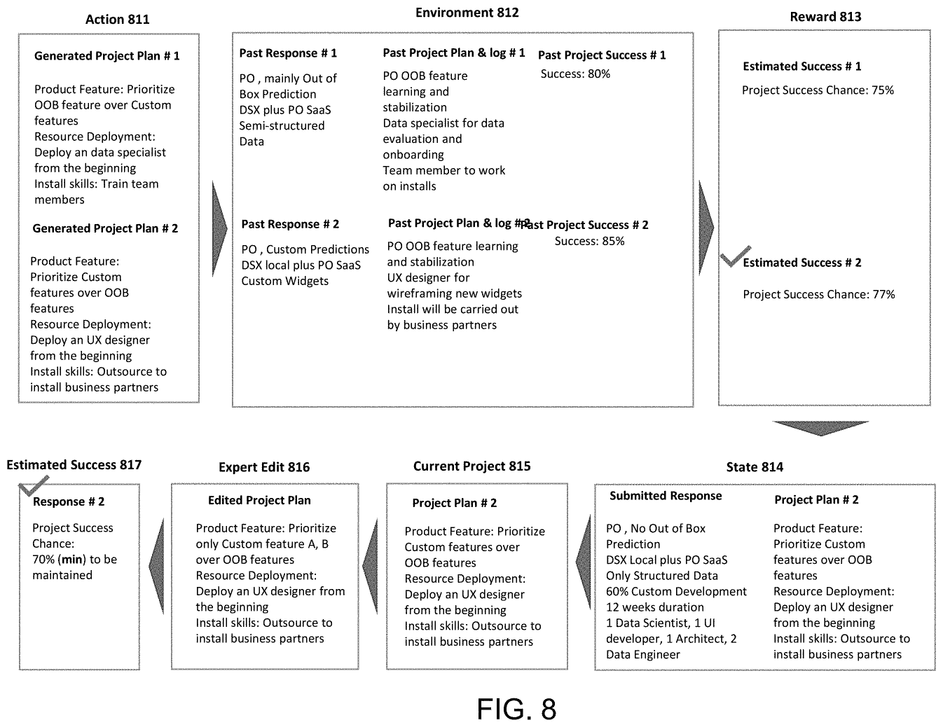

FIG. 8 illustrates an example of the project execution process according to some embodiments. Referring to FIGS. 4 and 8, the system receives as input the current bid response 104, prior bid responses 124, and prior projects 131 with prior product status of ‘success’ (Environment 812) (401). The system generates sets of candidate project plan parameters satisfying the current bid response 104 and based on prior projects 131 (Action 811) (402). The system determines the probability of project success for each set of candidate project plan parameters (Reward 813) (403). The system selects the set of candidate project plan parameters with the highest probability of project success (State 841) (404). The system generates the current project 111 to comprise the selected set of candidate project plan parameters (Current Project 815) (405). In this example, an expert user edits the current project 815 (Expert Edit 816). The edited current project 816 is input into the reinforcement learning setup to determine whether the probability of project success is maintained or improved (Estimated Success 817).

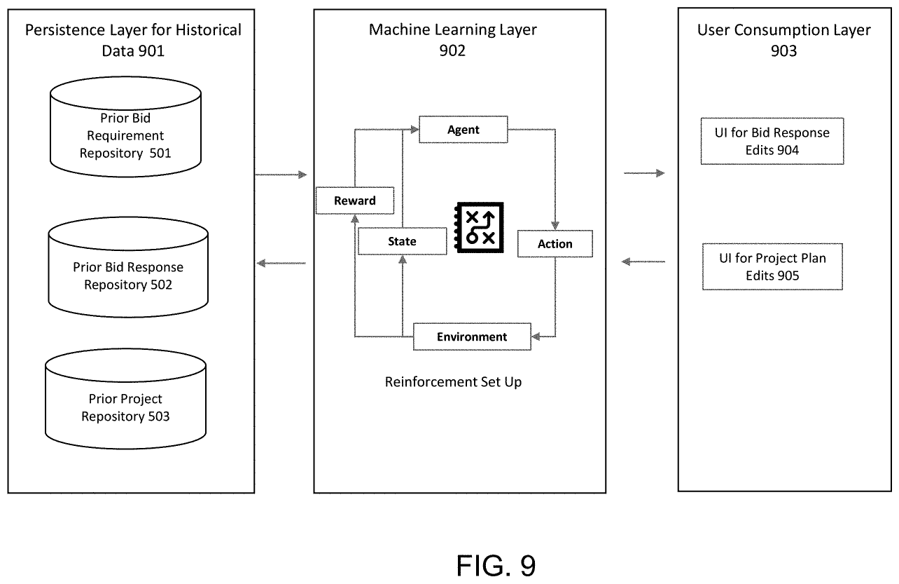

FIG. 9 illustrates a logical system for optimized bid response and project execution plan generation according to some embodiments. The logical system includes a persistence layer for the historical data 901, which includes the prior bid requirement repository 501, the prior bid response repository 502, and the prior project repository 503. The logical system further includes a machine learning layer 902 that implements the reinforcement learning setup described above, and a user consumption layer 903 that provides the user interfaces 904 and 905 for editing the bid response and for editing the project plan.

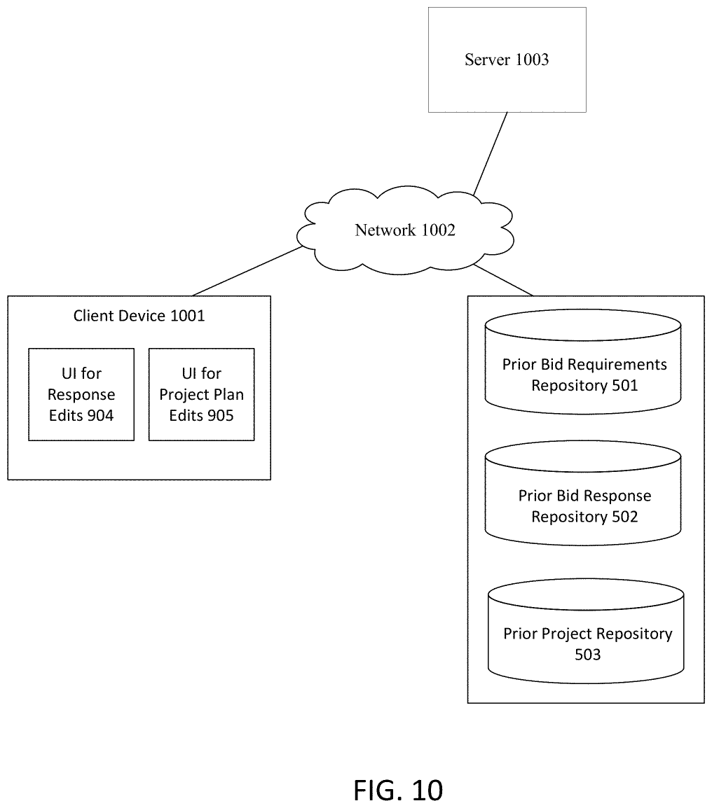

FIG. 10 illustrates a computing environment for optimized bid response and project execution plan generation according to some embodiments. The computing environment comprises one or more client devices 1001 configured to communicate with a server 1003 over a network 1002. The server 1003 implements the optimization of the bid response and project execution plan generation described above. The server 1003 is configured with access to the prior bid requirements repository 501, the prior bid response repository 502, and the prior project repository 503. The repositories 501-503 may be accessible over a network 1002 or local to the server 1003. The client device 1001 further implements the user interface for bid response edits 904 or the user interface for the project plan edits 905, or both.

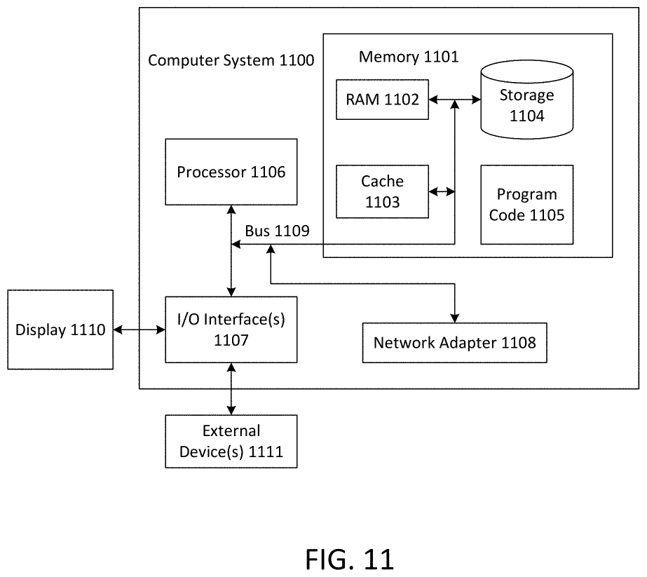

FIG. 11 illustrates a computer system, one or more of which implements the system for optimized bid response and project execution plan generation according to some embodiments. The computer system 1100 is operationally coupled to a processor or processing units 1106, a memory 1101, and a bus 1109 that couples various system components, including the memory 1101 to the processor 1106. The bus 1109 represents one or more of any of several types of bus structure, including a memory bus or memory controller, a peripheral bus, an accelerated graphics port, and a processor or local bus using any of a variety of bus architectures. The memory 1101 may include computer readable media in the form of volatile memory, such as random access memory (RAM) 1102 or cache memory 1103, or non-volatile storage media 1104. The memory 1101 may include at least one program product having a set of at least one program code module 1105 that are configured to carry out the functions of embodiment of the present invention when executed by the processor 1106. The computer system 1100 may also communicate with one or more external devices 1111, such as a display 1110, via I/O interfaces 1107. The computer system 1100 may communicate with one or more networks via network adapter 1108.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
at least one processor; and
a computer readable storage medium having program instructions embodied therewith, the program instructions executable by a processor to cause the processor to:
compare current bid requirements of a current bid with prior bid requirements of prior bids;
for prior bids with prior bid requirements matching the current bid requirements, retrieve prior bid responses corresponding to the prior bids and comprising a prior bid response status of win;
retrieve prior projects corresponding to the prior bid responses;
determine a set of candidate bid response parameters with a highest probability of winning the current bid and with a probability of project success meeting a configured minimum threshold, based on the prior bid responses and the prior projects;
generate a current bid response to comprise the candidate bid response parameters;
after winning the current bid, determine a set of candidate project plan parameters with highest probability of project success, based on the current bid response, the prior bid responses, and the prior projects; and
generate a current project corresponding to the current bid response to comprise the candidate project plan parameters.

2. The system of claim 1, wherein in retrieving the prior bid responses and retrieving the prior projects, the processor is further caused to:
select the prior bids comprising the prior bid requirements matching the current bid requirements;
retrieve the prior bid responses corresponding to the selected prior bids and comprising the prior bid response status of win, the prior bid responses comprising prior bid response parameters; and
retrieve the prior projects corresponding to the prior bid responses, the prior projects comprising prior project plan parameters.

3. The system of claim 2, wherein in determining the set of candidate bid response parameters, the processor is further caused to:
generate sets of candidate bid response parameters based on the prior bid responses comprising the prior bid response parameters and the prior projects comprising the prior project plan parameters;
for each set of candidate bid response parameters, determine the probability of winning the current bid and the probability of project success; and
select the set of candidate bid response parameters with the highest probability of winning the current bid and with the probability of project success meeting the configured minimum threshold.

4. The system of claim 3, wherein the set of candidate bid response parameters is selected using a reinforcement learning setup.

5. The system of claim 1, wherein in determining the set of candidate project plan parameters, the processor is further caused to:
receive the current bid response and the prior projects, the prior projects comprising prior project plan parameters and project status of success;
generate sets of candidate project plan parameters satisfying the current bid response and based on the prior projects comprising the prior project plan parameters;
for each set of candidate project plan parameters, determine the probability of project success; and
select the set of candidate project plan parameters with the highest probability of project success.

6. The system of claim 1, wherein the processor is further caused to:
receive modification of the current bid response from an expert user;
determine whether the current bid response with the modification has the highest probability of winning the current bid and with the probability of project success meeting the configured minimum threshold;
if the current bid response with the modification has the highest probability of winning the current bid and has the probability of project success meeting the configured minimum threshold, accept the modification; and
if the current bid response with the modification does not have the highest probability of winning the current bid or does not have the probability of project success meeting the configured minimum threshold, further modify the current bid response.

7. The system of claim 1, wherein the processor is further caused to:
receive modification of the current project from an expert user;
determine whether the current project with the modification has the highest probability of project success;
if the current project with the modification has the highest probability of project success, accept the modification; and
if the current project with the modification does not have the highest probability of project success, further modify the current project.

8. A computer-implemented method, comprising:
comparing, by a processor, current bid requirements of a current bid with prior bid requirements of prior bids;
for prior bids with prior bid requirements matching the current bid requirements, retrieving, by the processor, prior bid responses corresponding to the prior bids and comprising a prior bid response status of win;
retrieving, by the processor, prior projects corresponding to the prior bid responses;
determining, by the processor, a set of candidate bid response parameters with a highest probability of winning the current bid and with a probability of project success meeting a configured minimum threshold, based on the prior bid responses and the prior projects;
generating, by the processor, a current bid response to comprise the candidate bid response parameters;
after winning the current bid, determining, by the processor, a set of candidate project plan parameters with highest probability of project success, based on the current bid response, the prior bid responses, and the prior projects; and
generating, by the processor, a current project corresponding to the current bid response to comprise the candidate project plan parameters.

9. The method of claim 8, wherein the retrieving of the prior bid responses and retrieving the prior projects comprises:
selecting the prior bids comprising the prior bid requirements matching the current bid requirements;
retrieving the prior bid responses corresponding to the selected prior bids and comprising the prior bid response status of win, the prior bid responses comprising prior bid response parameters; and
retrieving the prior projects corresponding to the prior bid responses, the prior projects comprising prior project plan parameters.

10. The method of claim 9, wherein the determining of the set of candidate bid response parameters comprises:
generating sets of candidate bid response parameters based on the prior bid responses comprising the prior bid response parameters and the prior projects comprising the prior project plan parameters;
for each set of candidate bid response parameters, determining the probability of winning the current bid and the probability of project success; and
selecting the set of candidate bid response parameters with the highest probability of winning the current bid and with the probability of project success meeting the configured minimum threshold.

11. The method of claim 10, wherein the set of candidate bid response parameters is selected using a reinforcement learning setup.

12. The method of claim 8, wherein the determining of the set of candidate project plan parameters comprises:
receiving the current bid response and the prior projects, the prior projects comprising prior project plan parameters and project status of success;
generating sets of candidate project plan parameters satisfying the current bid response and based on the prior projects comprising the prior project plan parameters;
for each set of candidate project plan parameters, determining the probability of project success; and
selecting the set of candidate project plan parameters with the highest probability of project success.

13. The method of claim 8, further comprising:
receiving modification of the current bid response from an expert user;
determining whether the current bid response with the modification has the highest probability of winning the current bid and with the probability of project success meeting the configured minimum threshold;
if the current bid response with the modification has the highest probability of winning the current bid and has the probability of project success meeting the configured minimum threshold, accepting the modification; and
if the current bid response with the modification does not have the highest probability of winning the current bid or does not have the probability of project success meeting the configured minimum threshold, further modifying the current bid response.

14. The method of claim 8, further comprising:
receiving modification of the current project from an expert user;
determining whether the current project with the modification has the highest probability of project success;
if the current project with the modification has the highest probability of project success, accepting the modification; and
if the current project with the modification does not have the highest probability of project success, further modifying the current project.

15. A computer program product comprising a computer readable storage medium having program instructions embodied therewith, the program instructions executable by a processor to cause the processor to:
compare current bid requirements of a current bid with prior bid requirements of prior bids;
for prior bids with prior bid requirements matching the current bid requirements, retrieve prior bid responses corresponding to the prior bids and comprising a prior bid response status of win;
retrieve prior projects corresponding to the prior bid responses;
determine a set of candidate bid response parameters with a highest probability of winning the current bid and with a probability of project success meeting a configured minimum threshold, based on the prior bid responses and the prior projects;
generate a current bid response to comprise the candidate bid response parameters;
after winning the current bid, determine a set of candidate project plan parameters with highest probability of project success, based on the current bid response, the prior bid responses, and the prior projects; and
generate a current project corresponding to the current bid response to comprise the candidate project plan parameters.

16. The computer program product of claim 15, wherein in retrieving the prior bid responses and retrieving the prior projects, the processor is further caused to:
select the prior bids comprising the prior bid requirements matching the current bid requirements;
retrieve the prior bid responses corresponding to the selected prior bids and comprising the prior bid response status of win, the prior bid responses comprising prior bid response parameters; and
retrieve the prior projects corresponding to the prior bid responses, the prior projects comprising prior project plan parameters.

17. The computer program product of claim 16, wherein in determining the set of candidate bid response parameters, the processor is further caused to:
generate sets of candidate bid response parameters based on the prior bid responses comprising the prior bid response parameters and the prior projects comprising the prior project plan parameters;
for each set of candidate bid response parameters, determine the probability of winning the current bid and the probability of project success; and
select the set of candidate bid response parameters with the highest probability of winning the current bid and with the probability of project success meeting the configured minimum threshold.

18. The computer program product of claim 15, wherein in determining the set of candidate project plan parameters, the processor is further caused to:
receive the current bid response and the prior projects, the prior projects comprising prior project plan parameters and project status of success;
generate sets of candidate project plan parameters satisfying the current bid response and based on the prior projects comprising the prior project plan parameters;
for each set of candidate project plan parameters, determine the probability of project success; and
select the set of candidate project plan parameters with the highest probability of project success.

19. The computer program product of claim 15, wherein the processor is further caused to:
receive modification of the current bid response from an expert user;
determine whether the current bid response with the modification has the highest probability of winning the current bid and with the probability of project success meeting the configured minimum threshold;
if the current bid response with the modification has the highest probability of winning the current bid and has the probability of project success meeting the configured minimum threshold, accept the modification; and
if the current bid response with the modification does not have the highest probability of winning the current bid or does not have the probability of project success meeting the configured minimum threshold, further modify the current bid response.

20. The computer program product of claim 15, wherein the processor is further caused to:
receive modification of the current project from an expert user;
determine whether the current project with the modification has the highest probability of project success;
if the current project with the modification has the highest probability of project success, accept the modification; and
if the current project with the modification does not have the highest probability of project success, further modify the current project.
